(19) United States
(12) Patent Application Publication
(10) Pub. No.: US 2009/0316622 A1
(43) Pub. Date: Dec. 24, 2009

(54) METHOD AND APPARATUS FOR CONTROLLING PACKET FORWARDING, AND COMMUNICATION MODE

(75) Inventors: Jun Hirano, Kanagawa (JP); Chan Wah Ng, Singapore (SG); Pek Yew Tan, Singapore (SG); Tien-Ming Benjamin Koh, Singapore (SG)

Correspondence Address: Dickinson Wright PLLC;James E. Ledbetter, Esq., International Square, 1875 Eye Street, N.W., Suite 1200, Washington, DC, 20006, US

(73) Assignee: Matsushita Electric Industrial Co. Ltd., Osaka (JP)

(21) Appl. No.: 11/916,023

(22) PCT Filed: May 31, 2006
(86) PCT No.: PCT/JP2006/311367

§ 371 Date: Nov. 29, 2007

(51) Int. Cl. H04W 40/00; H04L 12/56

(52) U.S. Cl. 370/328; 370/392

(57) ABSTRACT

A technology is disclosed for reducing the number of encapsulations required when MAP forwards a packet to a mobile node which is layered within mobile networks, with mobile networks nested and multiple mobile routers chained behind MAP (Mobility Anchor Point). When a node 420 with Address A wants to send a packet to a node 450 with Address D, the node with Address A inserts a list of immediate addresses into the packet. The list includes a node 430 with Address B and a node 440 with Address C, and the destination address of the packet is set to a next hop destination Address B. The node with Address B receives the packet and swaps the destination address with Address C described in the list of immediate addresses. Similarly, the node with Address C processes the same swapping process, and then the packet reaches the node with Address D.

### TECHNICAL FIELD

The present invention relates to a packet forwarding control method and apparatus in packet-switched data communications networks such as an IP (Internet Protocol) network. More particularly, the present invention relates to a packet forwarding control method and apparatus to forward packets sent and received by nodes which use Mobile IP and HMIP (Hierarchical Mobile IP).

### BACKGROUND ART

Many devices today communicate with each other using the IP network. In order to provide mobility support to mobile devices, the Internet Engineering Task Force (IETF) has developed the “Mobility Support in IPv6” (see the following Non-patent Document 1). In Mobile IP, each mobile node has a permanent home domain. When the mobile node is attached to its home network, it is assigned a primary global address known as a home address (HoA).

When the mobile node is away, i.e. attached to some other foreign networks, it is usually assigned a temporary global address known as a care-of address (CoA). The idea of mobility support is such that the mobile node can be reached at the home-address even when it is attached to other foreign networks.

This is done in the Non-patent Document 1 with an introduction of an entity at the home network known as a home agent (HA) Mobile nodes register their care-of addresses with the home agents using Binding Update (BU) messages. This allows the home agent to create a binding between the home address and care-of address of the mobile node. The home agent is responsible to intercept messages that are addressed to the mobile node's home address, and forward the packet to the mobile node's care-of address using packet encapsulation (i.e. putting one packet as the payload of a new packet, also known as packet tunneling).

Although Mobile IP enables mobility support in the otherwise stationary addressing architecture of IP infrastructure, there exist a few deficiencies. One such deficiency is the need to send Binding Updates to home agents or correspondent nodes whenever the mobile device changes its point of attachment to the Internet. For a node with high mobility such as a mobile device on a vehicle, the frequency at which the mobile node needs to send Binding Updates becomes prohibitively high.

For this reason, the IETF is currently developing a Hierarchical Mobile IPv6 Mobility Management Protocol (HMIP, see the following Non-patent Document 2). The concept in HMIP is very similar to that contained in the following Patent Document 1. Here, an entity known as a Mobility Anchor Point (MAP) is defined, which handles a relatively large segment of an access network, allowing any mobile nodes roaming within the access network segment managed by a MAP to use the same care-of address. The trick here is for the mobile node to obtain a local care-of address (LCoA) for its current point of attachment, and register this LCoA with the MAP. Upon registration, a regional care-of-address (RCoA) will be assigned to the mobile node, which the mobile node uses to send Binding Updates to its home agent. Thus, any packets sent to the home address of the mobile node will be encapsulated by its home agent, and Forwarded to the RCoA of the mobile node. The MAP will intercept this packet, and tunnel it to the LCoA of the mobile node.

This greatly reduces the number of Binding Updates the mobile node needs to send to its home agent or correspondent nodes. As long as the mobile node moves within the access network segment managed by the same MAP, the mobile node will only change its LCoA while its RCoA remains unchanged. Thus, the mobile node only needs to notify the MAP of its LCoA, and need not send Binding Updates to its home agent or correspondent nodes. Only when the mobile node moves out of the access network segment managed by the original MAP, then a new RCoA needs to be assigned and the mobile node sends Binding Updates to its home agent or correspondent nodes.

The following Patent Document 2 further enhances HMIP by providing a mechanism for mobile nodes or correspondent nodes to detect failures of the MAP. When this happens, Patent Document 2 provides for a back-off method for the mobile node to fall back to use its LCoA as the care-of address while locating a new MAP.

With the ever-increasing proliferation of wireless devices, it is foreseeable that a new class of mobility technology will emerge: network mobility, or NEMO, where a whole network of nodes changes its point of attachment in entirety. Extending the concept of mobility support for individual hosts to mobility support for a network of nodes, the objective of a network in motion solution is to provide a mechanism where nodes in a mobile network can be reached by their primary global addresses, no matter where on the Internet the mobile network is attached to.

The IETF is currently developing solution for network mobility as disclosed in the following Non-patent Document 2. Here, it is specified that the mobile router when sending BU to its home agent, will specify the network prefix which the nodes in the mobile network are using. These are specified using special options known as Network Prefix Options to be inserted into the BU. These allow the home agent to build a prefix-based routing table so that the home agent will forward any packets sent to destinations with these prefixes to the care-of address of the mobile router. This idea of using the bidirectional tunnel between the mobile router and its home agent is also described in the following Patent Document 3.

Although this simple mechanism of bidirectional tunnel allows for network mobility support, a nesting of mobile networks will result in a long-winded path from a correspondent node to a node in a nested mobile network. This is because with each level of nesting (i.e. a mobile router attaching itself to a mobile network managed by another mobile router), a packet sent to a node in the innermost mobile network needs to go through an additional tunnel. Because the tunnel end-points are the home agents of mobile routers, these can be distributed all over the Internet, causing the packet to go through a long-winded path.

To solve this problem, another solution proposed in the following Non-Patent Document 4 involves the use of a Reverse Routing Header to avoid having too many levels of encapsulation when mobile network get nested (i.e. a mobile network attaching itself to another mobile network). Here, the downstream mobile router sets up a Reverse Routing Header in its tunnel packet to its home agent. As upstream mobile routers intercept this tunnel packet on its way, each upstream mobile router does not encapsulate this packet into another IP-in-IP tunnel. Instead, the upstream mobile router copies the source address in the packet to the Reverse Routing Reader, and puts its own care-of-address as the source address. In this way, when the home agent of the first mobile router receives the packet, it can determine the chain of mobile routers that is in the path between the first mobile router and itself. Subsequently when the home agent wishes to forward another intercepted packet for the first mobile router, it can include an extended Type 2 Routing Header so that the packet is directly sent to the first mobile router via other upstream mobile routers.

Nesting is not the only problem with network mobility support. As with Mobile IP, network mobility also faces the same issue of frequent Binding Updates if the network is moving rapidly. It is unclear how HMIP can be integrated to the network mobility support solution. One obvious approach is for a mobile router to register its LCoA with the MAP, obtain an RCoA from the MAP, and use this as the care-of address to send Binding Updates to its home agent. This, however, may arise to a long-winded routing when one considers nesting of mobile networks.

To illustrate this, consider the network deployment scenario depicted in FIG. 1. Here, the mobile router MR 142 is attached to the mobile network 104, which is managed by another mobile router MR 140. Mobile router MR 140 is attached to access router AR 130 that belongs to the access network 102 managed by the MAP 120. The mobile router MR 142 manages the mobile network 106 (in which, we show one mobile network node MN 150). Home agent HA 110 is the home agent for mobile router MR 140, home agent HA 112 is the home agent for mobile router 142, home agent 114 is the home agent for mobile node MN 150 and the network 100 is, for example, the global internet. All mobile routers MR 140, 142 and mobile node MN 150 use HMIP by registering with MAP 120.

Suppose CN 160 now sends a packet to MN 150. FIG. 2 depicts the path the packet will take to reach MN 150. First, the packet addressed to the home-address of MN 150 from CN 160 will take the path 210 to the home agent HA 114 of MN 150. HA 114 will then forward the packet to the RCoA of MN 150. This will result in the path 212 to the MAP 120. MAP 120 intercepts the packet, and tunnels it to the LCoA of MN 150. However, since the LCoA of MN 150 is configured from the prefix of mobile network 106, it will take the path 214 to the home agent HA 112 of the mobile router MR 142. HA 112 then forwards the packet to the RCoA of MR 142, taking the path 216 back to MAP 120.

MAP 120 tunnels this packet to the LCoA of MR 142. Again, since LCoA of MR 142 is configured from the prefix of the mobile network 104, it will take the path 218 to the home agent HA 110 of the mobile router MR 140. HA 110 then forwards the packet to the RCoA of MR 140, taking the path 220 to MAP 120. MAP 120 tunnels the packet to the LCoA of MR 140 with the path 222. MR 140 decapsulates the packet, and forwards it to MR 142. Finally, MR 142 decapsulates the packet, and forwards it to MN 150.

From the above description, one can see the problem of simply combining HMIP with network mobility support. A packet addressed to a mobile node in a nested mobile network will take a long-winded path, possibly passing through the MAP multiple times. Not only is this a waste of network resources, it also greatly increases the packet latency. This can be unacceptable for real-time applications, such as voice-over-IP or other multimedia sessions that are getting more and more popular.

It might be plausible for one to extend the concept of sending prefix information with Binding Updates in network mobility support to HMIP. Alternatively, the MAP can delegate prefix to mobile routers when they register with it. This delegated prefix can then be used in the mobile network managed by the mobile router so that mobile nodes attached to the mobile network can configure their LCoAs from the delegated prefix.

In both cases, the MAP will be aware of the prefix handled by a mobile router when the mobile router registers with the MAP. When the MAP receives a packet addressed to the RCoA of a mobile node, it can check the prefix table and realize that the mobile node has an LCoA within the prefix of the mobile network, and instead of tunneling the packet straight to the LCoA of the mobile node, it tunnels the packet to the mobile router. Doing so will cause the routing path shown in FIG. 2 to be greatly shortened with the extra paths 214, 216, 218 and 220 removed.

[patent Document 1] Malki, K., Soliman, H., “Hierarchical Mobility Management For Wireless Networks”, US Patent Application No 2001/0046223A1, November 2001.

[Patent Document 2]: Venkitaraman, N., “Method and Apparatus for Robust Local Mobility Management in a Mobile Network”, US Patent Application No 2003/0185196A1, October 2003.

[Patent Document 3] Leung, K. K., “Mobile IP mobile router”, U.S. Pat. No. 6,636,498, October 2003.

[Non-patent Document 1]: Johnson, D. B., Perkins, C. E., and Arkko, J., “Mobility Support in IPv6”, Internet Engineering Task Force (IETF) Request For Comments (RFC) 3775, June 2004.

[Non-patent Document 2]: Soliman, H., et. al., “Hierarchical Mobile IPv6 Mobility Management (HMIPv6)”, IETF Internet Draft: draft-ietf-mipshop-hmipv6-04.txt, Work-in-progress, December 2004.

[Non-patent Document 3]: Devarapalli, V., et. al., “NEMO Basic Support Protocol”, IETF RFC 3963, January 2005.

[Non-patent Document 4]: Thubert, P., and Molteni, M., “IPv6 Reverse Routing Header and Its Application to Mobile Networks”, Internet Draft: draft-thubert-nemo-reverse-routing-header-04.txt, Work In Progress, February 2004.

Although the use of prefix information can eliminate the long-winded routing problem, it does not solve all problems. The MAP will still need to encapsulate packets to the mobile routers. To illustrate this problem, consider the previous example depicted in FIG. 2. Although MAP 120 uses prefix information to remove the unnecessary paths 214, 216, 218 and 220, it still needs to tunnel the packet first to the LCoA of MN 150, then to the LCoA of MR 142, and finally to the LCoA of MR 140. On top of the original encapsulation by HA 114, the packet is encapsulated four times.

This is illustrated in FIG. 3. Here, we see that the path 310 from CN 160 to MN 150 needs to go through the tunnel 320 from HA 114 to MN 150, tunnel 330 from MAP 120 to MN 150, tunnel 340 from MAP 120 to MR 142, and tunnel 350 from MAP 120 to MR 140.

So, there is a problem that each additional level of encapsulation adds a significant header overhead to the packet, and thus will incur a substantial processing delay at each encapsulating/decapsulating node. Furthermore, there is another problem that the chances of packet fragmentation en route also increase.

### DISCLOSURE OF THE INVENTION

In light of the foregoing Issues, it is thus an object of the present invention to reduce the number of encapsulations required when MAP forwards a packet to a mobile node which is layered within mobile networks, with mobile networks nested and multiple mobile routers chained behind MAP.

In order to achieve the foregoing object, the present invention provides a method of controlling packet forwarding in a communication system, the communication system including a mobility anchor point which manages a hierarchical network, a mobile router which comprises a mobile network and a mobile node which is attached to the mobile network, the mobility anchor point storing address binding information on a binding between a local address for identifying location of a communication node within a network of the mobility anchor point and a global address used by the correspondent node to communicate with an outside of the network, the mobile node using an address configured based on a prefix advertised within the mobile network to communicate, wherein the mobile node is attached under the mobility anchor point's control, and wherein the mobility anchor point stores the address binding information on both the mobile router and the mobile node, the method comprising:

a prefix grasping step in which the mobility anchor point grasps the prefix of the mobile network which the mobile router comprises behind; and

an immediate address list producing step in which the mobility anchor point produces an address list including a single or plurality of addresses of mobile routers which are on route from the mobility anchor point to the mobile node.

Moreover, in addition to the above-mentioned, the method of controlling packet forwarding of the present invention comprises a packet forwarding step in which, when the mobility anchor point forwards a packet addressed to the global address of the mobile node, the mobility anchor point adds the address list to the packet, encapsulates the packet and sets the local address of the mobile router which is located on a next hop as the destination address of the encapsulated packet.

Moreover, in addition to the above-mentioned, in the method of controlling packet forwarding of the present invention, the address list is inserted into a routing header which is appended to the encapsulated packet.

Moreover, in addition to the above-mentioned, the method of controlling packet forwarding of the present invention comprises a destination address swapping step in which the mobile routers which are transfer points between the mobile node and the mobility anchor point, upon forwarding the encapsulated packet, check the address list and swap a destination address of the encapsulated packet with the local address of the mobile router described at the predetermined point in the address list.

Moreover, in addition to the above-mentioned, the method of controlling packet forwarding of the present invention comprises:

an address list acquiring step in which the mobile node acquires the address list; and

a packet sending step in which the mobile node, upon sending a packet through the mobility anchor point, adds a reverse address list in which the addresses in the address list are arranged in reverse order to the packet, encapsulates the packet and sets a destination address of the encapsulated packet to the mobility anchor point, and sends the encapsulated packet.

Moreover, in addition to the above-mentioned, in the method of controlling packet forwarding of the present invention, the reverse address list is inserted into a reverse routing header which is appended to the encapsulated packet.

Moreover, in addition to the above-mentioned, the method of controlling packet forwarding of the present invention comprises a source address swapping step in which the mobile routers which are transfer points between the mobile node and the mobility anchor point, upon forwarding the encapsulated packet, check the reverse address list and swap a source address of the encapsulated packet with its own local address.

Furthermore, in order to achieve the foregoing object, the present invention provides an apparatus for controlling packet forwarding arranged in a mobility anchor point which manages a hierarchical network, comprising;

a registration table storing means for storing address binding information on a binding between a local address for identifying location of a communication node within a network of the mobility anchor point and a global address used by the correspondent node to communicate with an outside of the network;

a prefix storing means for storing a prefix of a mobile network behind a mobile router whose address binding information is registered at the registration table storing means; and

an immediate address list producing means for producing an address list including a single or plurality of addresses of mobile routers which are on route from the mobility anchor point to the mobile node.

Moreover, in addition to the above-mentioned, the apparatus for controlling packet forwarding of the present invention comprises:

an encapsulating means for, when the mobility anchor point forwards a packet addressed to the global address of the mobile node, adding the address list to the packet, and encapsulating the packet; and

an address setting means for setting the local address of the mobile router which is located on a next hop as the destination address of the encapsulated packet.

Furthermore, in order to achieve the foregoing object, the present invention provides an apparatus for controlling packet forwarding arranged in a mobile router which comprises a mobile network, comprising;

a packet receiving means for receiving, from an upper-level mobility anchor point, an encapsulated packet which an address list including a plurality of addresses is added to;

a destination address swapping means for checking the address list and swapping a destination address of the encapsulated packet with the local address of the mobile router described at the pre-determined point in the address list; and

a packet sending means for sending the encapsulated packet that the destination address has been swapped.

Furthermore, in order to achieve the foregoing object, the present invention provides an apparatus for controlling packet forwarding arranged in a mobile router which comprises a mobile network, comprising;

a packet receiving means for receiving, from a mobile node within the mobile network, an encapsulated packet which an address list including a plurality of addresses is added to;

a source address swapping means for checking the address list and swapping a source address of the encapsulated packet with its own local address in the address list; and

a packet sending means for sending the encapsulated packet that the source address has been swapped.

Furthermore, in order to achieve the foregoing object, the present invention provides a communication node within a mobile network formed by a mobile router, the mobile router being under control of a mobility anchor point, comprising:

an address list acquiring step in which the mobile node acquires an address list including a single or plurality of addresses of mobile routers which are on route from the mobility anchor point to the mobile node; and

a packet sending means for, upon sending a packet through the mobility anchor point, adding a reverse address list in which the addresses in the address list are arranged in reverse order to the packet, encapsulating the packet and setting a destination address of the encapsulated packet to the mobility anchor point, and sending the encapsulated packet.

The present invention comprising the foregoing construction has the advantage of reducing the number of encapsulations required when MAP forwards a packet to a mobile node which is layered within mobile networks, with mobile networks nested and multiple mobile routers chained behind MAP.

### BRIEF DESCRIPTION OF THE DRAWINGS

FIG. 1 is a diagram showing an example of common network arrangement in the prior art and the embodiments of the present invention;

FIG. 2 is a diagram showing routes of packets sent from CN to MN in FIG. 1 when utilizing the prior art;

FIG. 3 is a schematic diagram of multiple levels of packet encapsulation via routes shown in FIG. 2;

FIG. 4 is a diagram showing an example of a packet format with a routing header in the embodiments of the present invention;

FIG. 5 is a schematic diagram showing changes of a packet header when the packet with a routing header is forwarded from a node with address A to a node with address D in the embodiments of the present invention;

FIG. 6 is a diagram showing an example of a packet format with a reverse routing header in the embodiments of the present invention;

FIG. 7 is a schematic diagram showing changes of a packet header when the packet with a reverse routing header is forwarded from a node with address A to a node with address D in the embodiments of the present invention;

FIG. 8 is a diagram showing an example of architecture of MAP in the embodiments of the present invention;

FIG. 9 is a diagram showing an example of the Prefix Table which MAP stores in the embodiments of the present invention;

FIG. 10 is a diagram showing an example of the Registration Table which MAP stores in the embodiments of the present invention;

FIG. 11 is a flowchart showing an example of an algorithm used when the routing unit of MAP constructs a list of immediate addresses to reach a mobile node in the embodiments of the present invention;

FIG. 12 is a diagram showing an example of contents of a tunnel packet sent from MAP to MN in the embodiments of the present invention;

FIG. 13 is a diagram showing an example of contents of a tunnel packet sent from MN to MAP in the embodiments of the present invention;

FIG. 14 is a flowchart showing an example of an algorithm used by the routing unit of MAP, when MAP receives a packet destined to the address within an access network managed by MAP, in the embodiments of the present invention;

FIG. 15 is a sequence chart showing examples of message exchanges about registration and packet forwarding in case of using a routing header and a reverse routing header in the network architecture shown in FIG. 1;

FIG. 16 is a sequence chart showing an example of packet forwarding in case of using DF-Option in the network architecture shown in FIG. 1;

FIG. 17 is a sequence chart showing an example of packet forwarding in case of using S-Prefix in the network architecture shown in FIG. 1;

FIG. 18 is a flowchart showing an example of an algorithm used when MAP performs the sanity check of a packet in which a routing header is used in the embodiments of the present invention; and

FIG. 19 is a flowchart showing an example of an algorithm used when MAP performs the sanity check of a packet in which DF-Option or S-Prefix is used in the embodiments of the present invention.

### BEST MODE FOR CARRYING OUT THE INVENTION

Description will be given below on the preferred aspects of the present invention referring to the drawings.

The present invention describes a method used by a mobility anchor point (MAP) to eliminate the need for multiple levels of tunnel encapsulations related to mobile nodes nested within mobile networks. The basic principle is for the MAP to construct, based on prefix information associated to a registered mobile router, a list of intermediate addresses in order to reach a mobile node. This list of intermediate addresses is then placed into a routing header whenever a packet arrives that needs to be forwarded to the mobile node. In addition, this list of intermediate addresses is also conveyed to the mobile node, so that whenever the mobile node needs to forward a packet through the MAP, it can place this list of intermediate addresses into a reverse routing header.

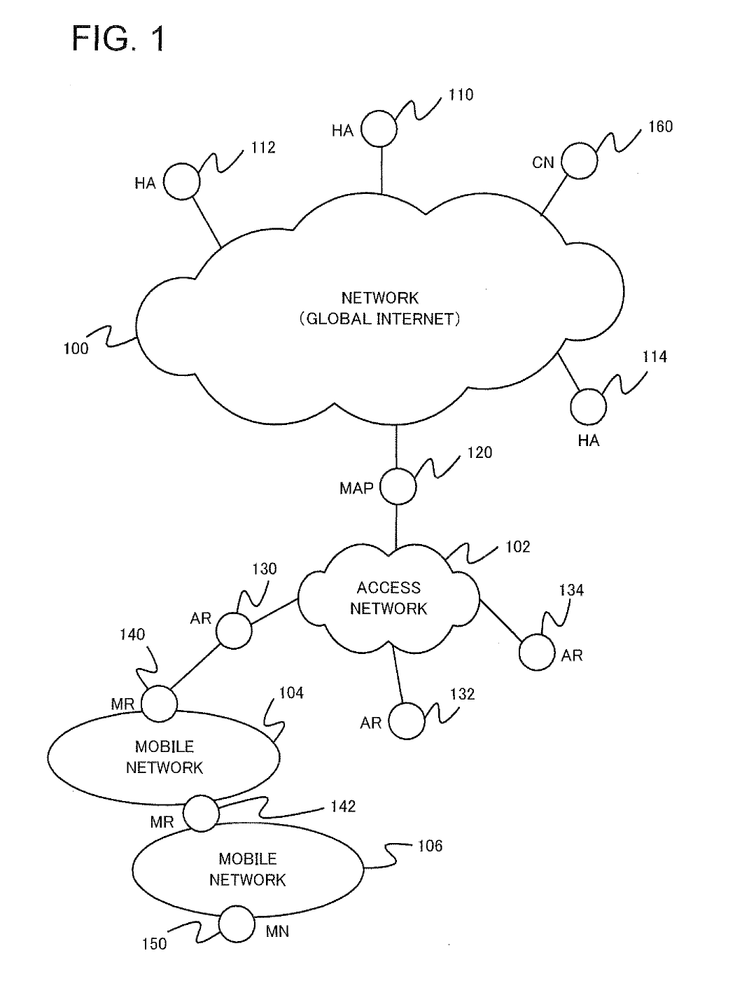

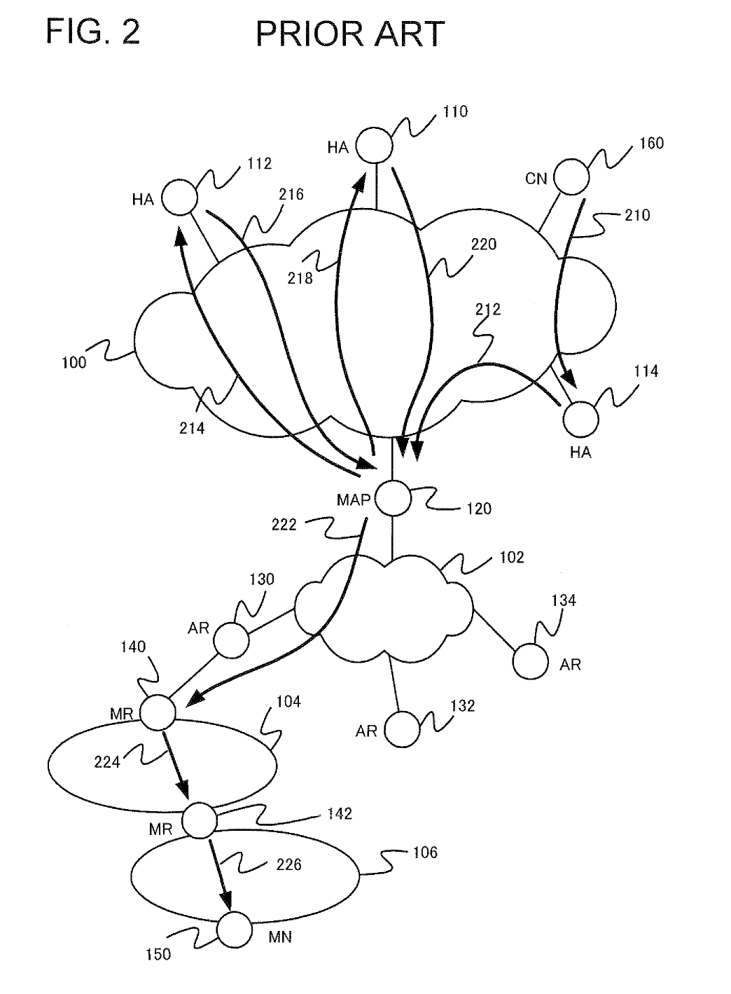

Using the deployment scenario shown in FIG. 1, when mobile node MN 150 registers with MAP 120, MAP 120 calculates the intermediate addresses to reach mobile node MN 150 based on prefix information of mobile routers MR 140 and MR 142. This list of intermediate addresses turns out to be the LCoA of mobile router 140, the LCoA of mobile router 142, and the LCoA of MN 150. This list of intermediate addresses is conveyed to MN 150.

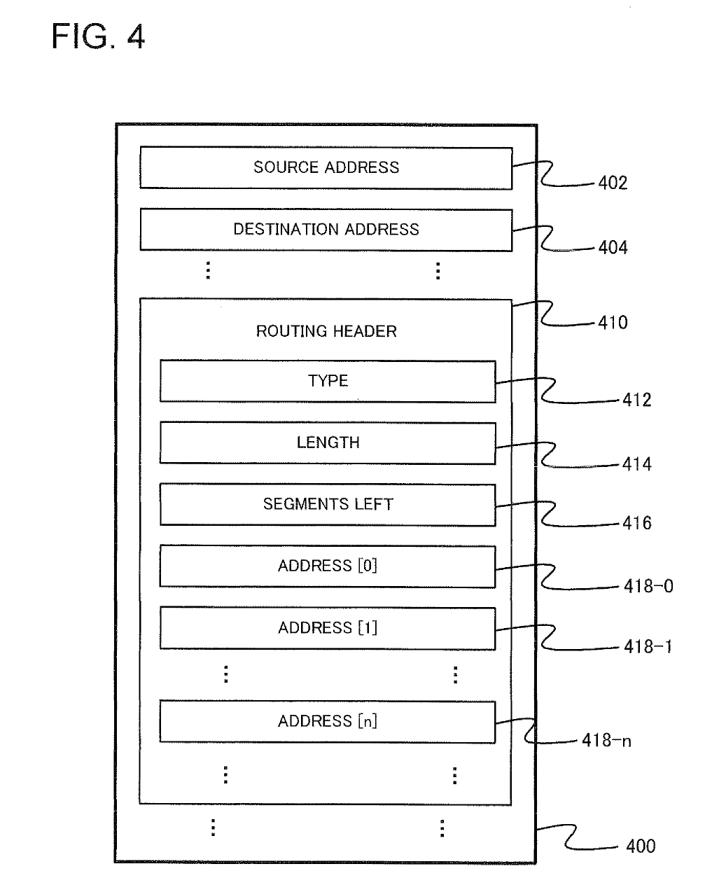

FIG. 4 shows the message format of packet 400 with a routing header 410. The source address field 402 contains the address of the sender, and the destination address field 404 contains the address of the next intermediate destination.

The type field 412 of the routing header 410 indicates this as a routing header, and the length field 414 contains the size of the routing header 410, given in terms of number of 8 octets. The segments length field 416 gives the number of addresses 418 in the routing header 410 that are not processed. The number of addresses in the routing header is dynamic, and this is shown in FIG. 4 with the addresses 418-0, 418-1 through 418-n, where n+1 is the number of addresses in the routing header.

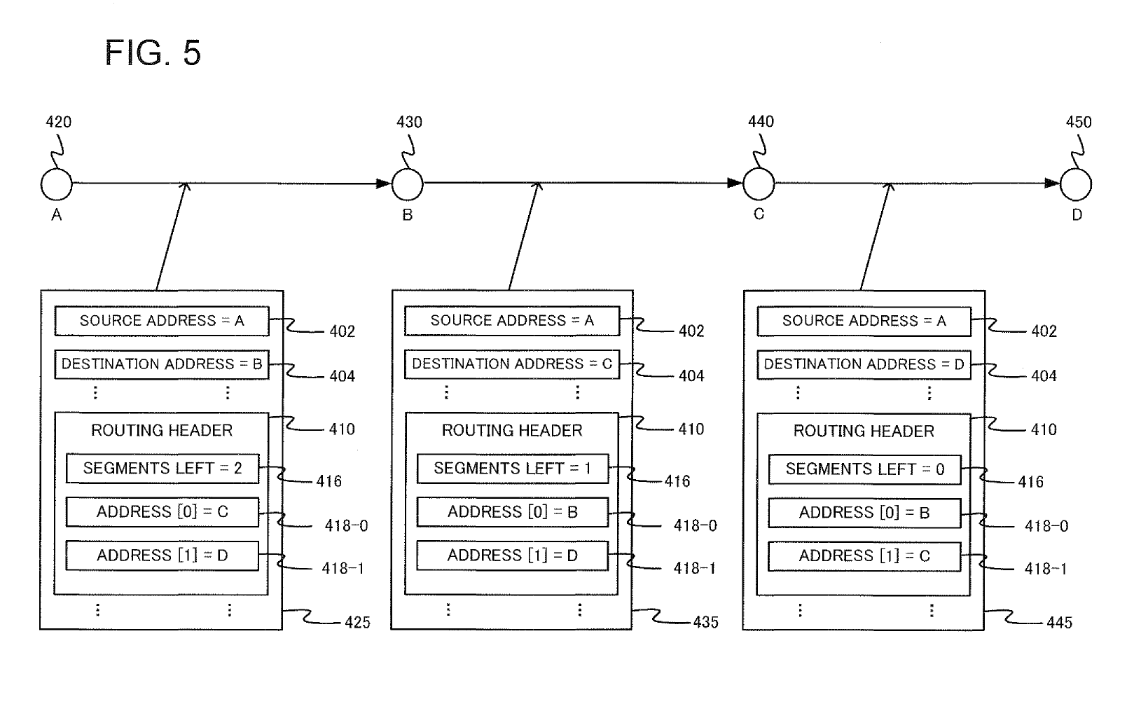

To illustrate how the routing header works, consider the simple example shown in FIG. 5 where a node 420 with address A sends a packet to a node 450 with address D. Node 420 inserts a routing header to the packet so that the packet will pass through the node 430 with address B and the node 440 with address C. Initially, the content of the packet is shown in packet snapshot 425.

Here, the source address 402 contains the address A and the destination address 404 contains the first intermediate address B. The segments left field 416 of the routing header 410 contains the number 2, indicating that there are two more intermediate addresses not reached. Address [0] field 418-0 of the routing header 410 contains the address C, and address [1] field 418-1 of the routing header 410 contains the address D.

When the node 430 receives this packet, it notices that the routing header 410 still has unprocessed addresses. So it swaps the destination field 404 with the next unprocessed address (address C) and decrements the segments left field 416. So when the packet leaves the node 430, its content is shown in the packet snapshot 435.

Here, the source address 402 contains the address A and the destination address 404 contains the next intermediate address C. The segments left field 416 of the routing header 410 contains the number 1, indicating that there is one more intermediate address not reached. Address [0] field 418-0 of the routing header 410 contains the address B, and address [1] field 418-1 of the routing header 410 contains the address D.

When the node 440 receives this packet, it notices that the routing header 410 still has one unprocessed address. So it swaps the destination field 404 with the next unprocessed address (address D) and decrements the segments left field 416. So when the packet leaves the node 440, its content is shown in the packet snapshot 445.

Here, the source address 402 contains the address A and the destination address 404 contains the next (and final) intermediate address D. The segments left field 416 of the routing header 410 contains the number 0, indicating that all intermediate addresses have been reached. Address [0] field 418-0 of the routing header 410 contains the address B, and address [1] field 418-1 of the routing header 410 contains the address C. When the node 450 receives this packet, it knows it is the final destination, since the segments left field 416 is now zero.

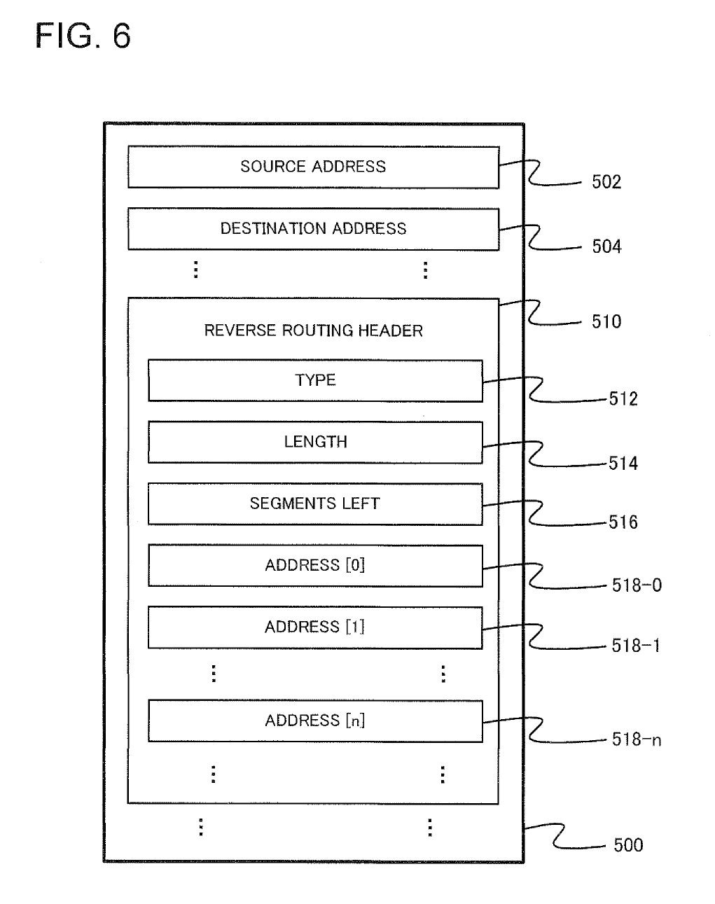

FIG. 6 shows the message format of packet 500 with a reverse routing header 510. The source address field 502 contains the address of the sender, and the destination address 504 contains the address of the next intermediate sender. The type field 512 of the routing header 510 indicates this as a reverse routing header, and the length field 514 contains the size of the reverse routing header 510, given in terms of number of 8 octets. The segments length field 516 gives the number of addresses 518 in the routing header 510 that are not processed. The number of addresses in the reverse routing header is dynamic, and this is shown in FIG. 6 with the addresses 518-0, 518-1 through 518-n, where n+1 is the number of addresses in the reverse routing header.

The reverse routing header works much the same way as the routing header, except that instead of storing the intermediate destination addresses, it stores the intermediate source addresses. This is necessary to overcome ingress filtering, where intermediate routers may discard packets received from a given network if the source address of the packet does not belong to a specific prefix.

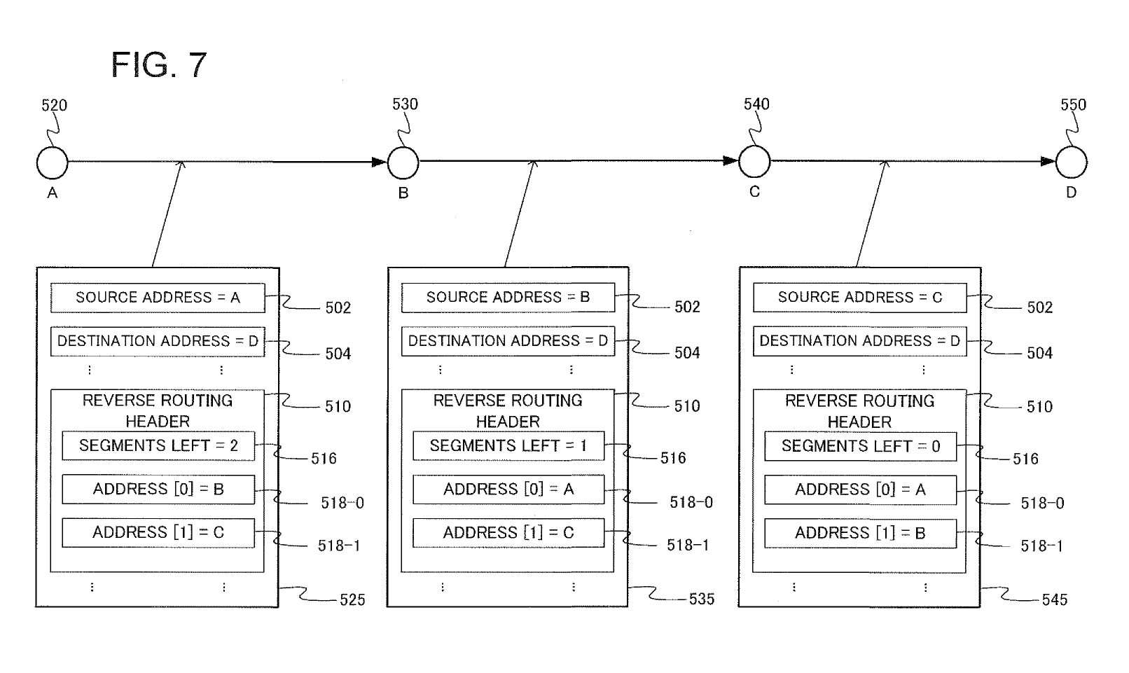

To illustrate how the reverse routing header works, consider the simple example shown in FIG. 7 where a node 520 with address A sends a packet to a node 550 with address D. Node 520, knowing the packet will pass through a node 530 with address B and a node 540 with address C in order to reach node 550, inserts a reverse routing header to the packet. Initially, the content of the packet is shown in packet snapshot 525.

Here, the source address 502 contains the initial sender address A and the destination address 504 contains the address D. The segments left field 516 of the reverse routing header 510 contains the number 2, indicating that there are two more intermediate addresses not reached. Address [0] field 518-0 of the routing header 510 contains the address B, and address [1] field 518-1 of the routing header 510 contains the address C.

When the node 530 receives this packet, it notices that the reverse routing header 510 still has unprocessed addresses. So it swaps the source address field 502 with the next unprocessed address (address C) and decrements the segments left field 516. So when the packet Leaves node 530, its content is shown in the packet snapshot 535.

Here, the source address 502 contains the address B and the destination address 504 contains the address D. The segments left field 516 of the reverse routing header 510 contains the number 1, indicating that there is one more intermediate address not reached. Address [0] field 518-0 of the reverse routing header 510 contains the address A, and address [1] field 518-1 of the reverse routing header 510 contains the address C.

When the node 540 receives this packet, it notices that the reverse routing header 510 still has one unprocessed address. So it swaps the source address field 502 with the next unprocessed address (address D) and decrements the segments left field 516. So when the packet leaves node 540, its content is shown in the packet snapshot 545.

Here, the source address 502 contains the address C and the destination address 504 contains the address D. The segments left field 516 of the reverse routing header 510 contains the number 0, indicating that all intermediate addresses have been reached. Address [0] field 518-0 of the reverse routing header 510 contains the address A, and address [1] field 518-1 of the reverse routing header 510 contains the address B.

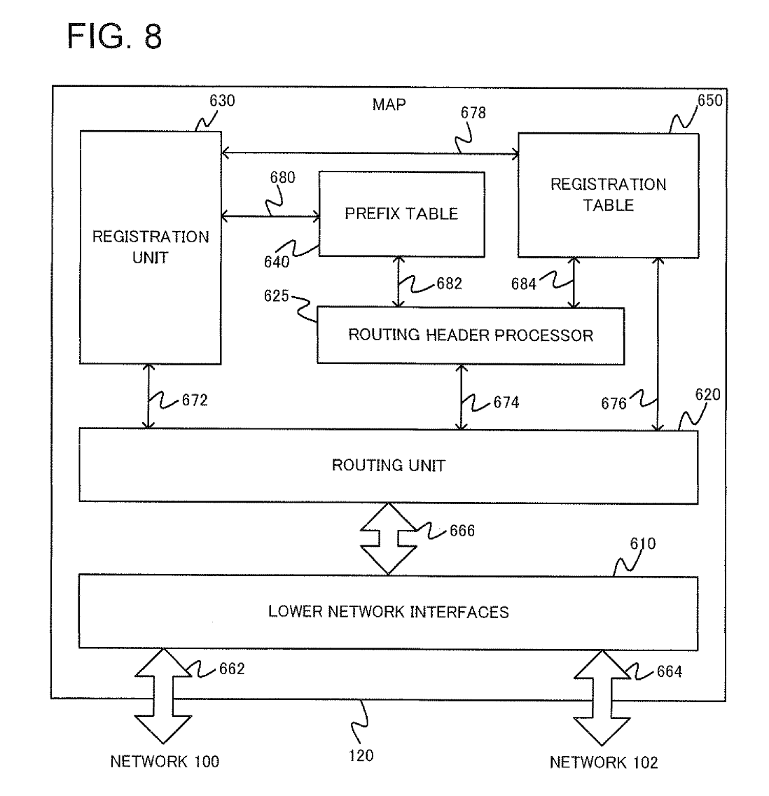

To employ the routing headers, the present invention specifies that MAP 120 should have a functional architecture as shown in FIG. 8, comprising a Lower Network Interface 610, a Routing Unit 620, a Routing Header Processor 625, a Registration Unit 630, a Prefix Table 640, and a Registration Table 650.

The Lower Network Interface 610 is a functional block that represents all networking hardware, software and protocols that are necessary to allow the MAP 120 to communicate with other nodes on a packet-switched data communication network. For instances, under the International Standards Organization's (ISO) Open System Interconnect (OSI) 7-layers model, the Lower Network Interface 610 will encompass the Physical and Data Link Layers. Packets received from a network 100 or an access network 102 will go through the packet path 662 or 664 to be processed by the Lower Network Interface 610. If the packet is intended for MAP 120 by the physical address, it will be passed to the Routing Unit 620 via packet path 666.

The Routing Unit 620 handles all processing with respect to routing in the internetworking layer. Under the OSI model, it encompassed all functionalities of Network Layer. The Routing Unit 620 is responsible for forwarding packets to their next hops based on their final destination. To do its work correctly, the Routing Unit 620 will need to consult the Registration Table 650 via the signal path 676 to check for mapping of RCoA to LCoA from the Registration Table 650. Should the need arise, the Routing Header Processor 625 will be consulted via signal path 674 to construct/verify a routing header.

The Routing Header Processor 625 Will need to query the Registration Table 650 and Prefix Table 640 to properly construct a routing header. It does this via the signal paths 682 and 684. If the received packet is actually a registration message from a mobile node, the message will be passed to the Registration Unit 630 for further processing via signal path 672.

The Registration Unit 630 is responsible for maintaining mobile node's registration. It will create the mapping of RCoA to LCoA of a mobile node when a mobile node makes registration and stores the mapping into the Registration Table 650 via the signal path 678. In addition, when the mobile node is a mobile router, the Registration Unit 630 will also maintain the prefix information of the mobile network associated with the mobile router. The prefix information is stored in the Prefix Table 640 via the signal path 680.

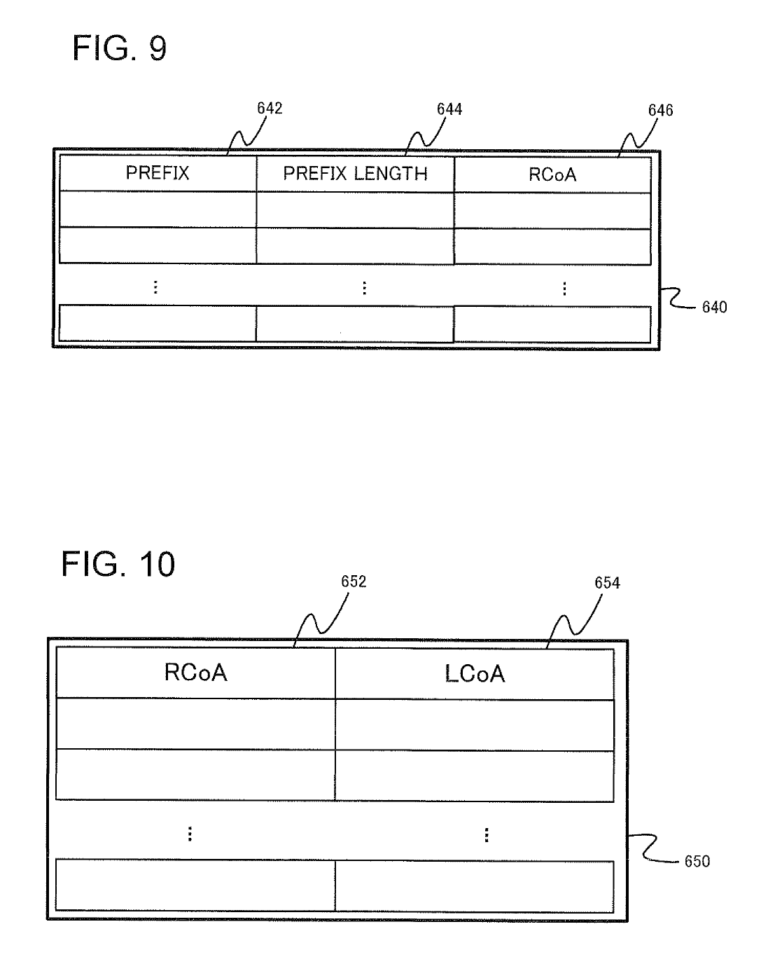

FIG. 9 shows the contents of the Prefix Table 640. It is basically a logical data structure where each row in the table corresponds to a prefix entry for a mobile network. Each entry comprises at least the Prefix field 642 storing the address prefix of the mobile network, the Prefix Length field 644 storing the number of significant bits of the address prefix, and the RCoA field 646 storing the RCoA of the mobile router associated to the mobile network.

Although the Prefix Table 640 is described to contain the RCoA field 646, it should be obvious to any person skilled in the art that one can use the LCoA instead of the RCoA in the Prefix Table 640. All that is needed is a form of identifier to link the entry in the Prefix Table 640 to a mapping in the Registration Table 650. Furthermore, it should also be obvious to any person skilled in the art that the Prefix Length field 644 may be omitted from Prefix Table 640 if some other means exist for one to deduce the prefix length. One example may be some organization standardizing the number of significant bits in a prefix to be a constant number. Another example will be a particular pattern of bits in the prefix would indicate the length of the prefix as well. In addition, the readers should note that there is no loss of generality whether the prefix is one that is owned by the mobile router or one that is delegated by some other entity (such as MAP 120 itself).

FIG. 10 shows the contents of the Registration Table 650. It is basically a logical data structure where each row in the table corresponding to a mapping entry for one mobile node. Each entry comprises at least the RCoA field 652 storing the RCoA of the mobile node and the LCoA field 654 storing the LCoA of the mobile node.

With the functional architecture of MAP 120 fully described, we can now explain its operations in order to achieve the object of the present invention. Whenever MAP 120 receives a registration message from a mobile node, the Registration Unit 630 will insert the appropriate entry in the Registration Table 650 to store the mapping of the LCoA and RCoA of the mobile node. If the mobile node is a mobile router, the Registration Unit 630 will also insert an entry in the Prefix Table 640 to store the mapping of the prefix information to the RCoA of the mobile router. In addition, the Routing Header Processor 625 will construct a list of intermediate addresses to reach the mobile node.

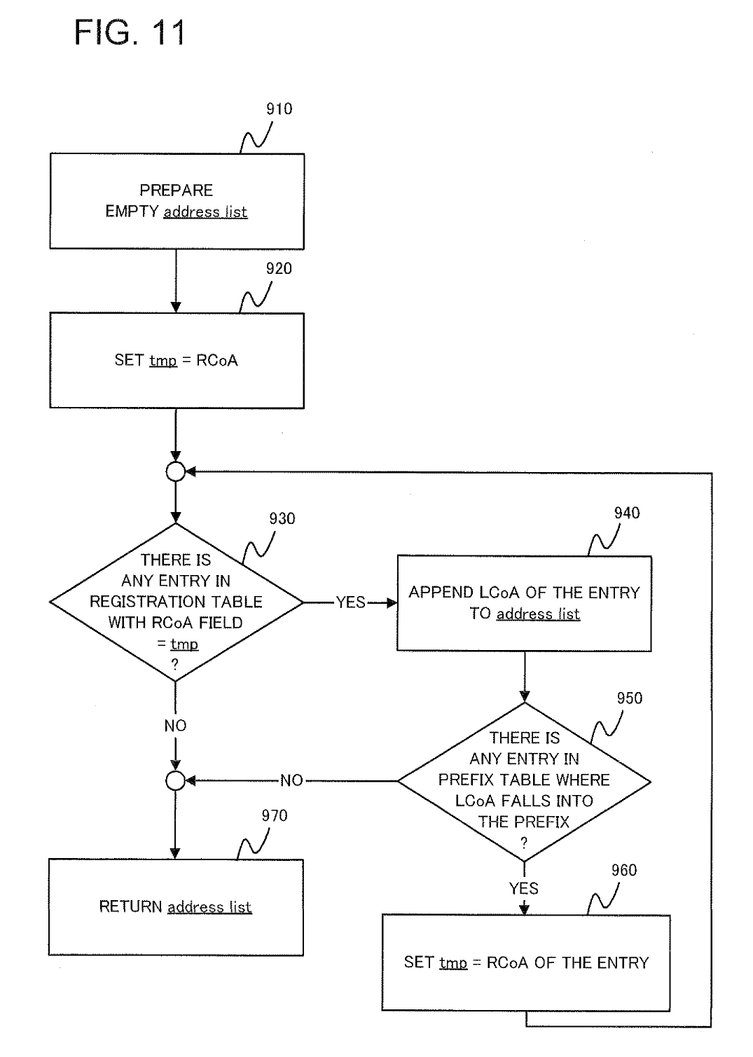

FIG. 11 shows the flowchart of how the Routing Header Processor 625 constructs the list of intermediate addresses to reach the mobile node, given the RCoA of the mobile node. Note that the algorithm depicted in FIG. 11 gives the list of intermediate addresses to reach the mobile node in reverse order. In step 910, an empty list (address list) of intermediate addresses is first initialized. Also, a temporary address store (tmp) is initialized to contain the RCoA of the mobile node, as shown in step 920.

After which, an iteration begins at step 930, where the Registration Table 650 is checked for an entry with a RCoA field 652 that matches the address contained in the temporary address store. If no match is found, the algorithm exits and the list of intermediate addresses is returned in reverse order, as shown in step 970. If a match is found, step 940 is taken, where the LCoA contained in the LCoA field 654 of the matching entry in the Registration Table 650 is appended to the list of intermediate addresses. Then, in step 950, this LCoA is checked against the prefix information of each entry in the Prefix Table 640 for a matched prefix according to the Prefix field 642 and Prefix Length field 644.

If there is no matching entry, the iteration exits and step 970 is taken, where the list of intermediate addresses is returned in reverse order. If a matching entry is found from the Prefix Table 640, the address contained in the RCoA field 646 of the matching entry is stored in the temporary address store as shown in step 960. The algorithm then re-iterates to step 930.

Having obtained the list of intermediate addresses, MAP 120 then uses this list to insert a routing header to a registration response to be replied to the mobile node such that the routing header will cause the registration response to reach the mobile node via the list of intermediate addresses. When the mobile node receives this registration response, it can store the address fields 418 of the routing header in the registration response in reverse order. This reverse order gives the order to be used in a reverse routing header the mobile node needs when it is sending packet to MAP 120 for further forwarding.

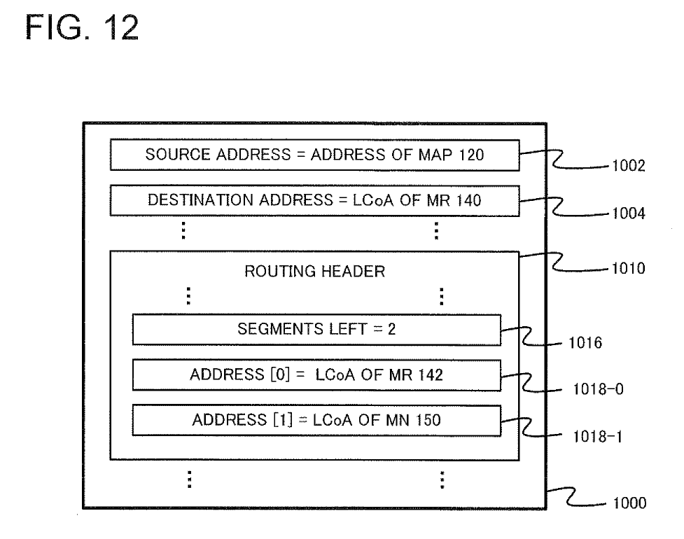

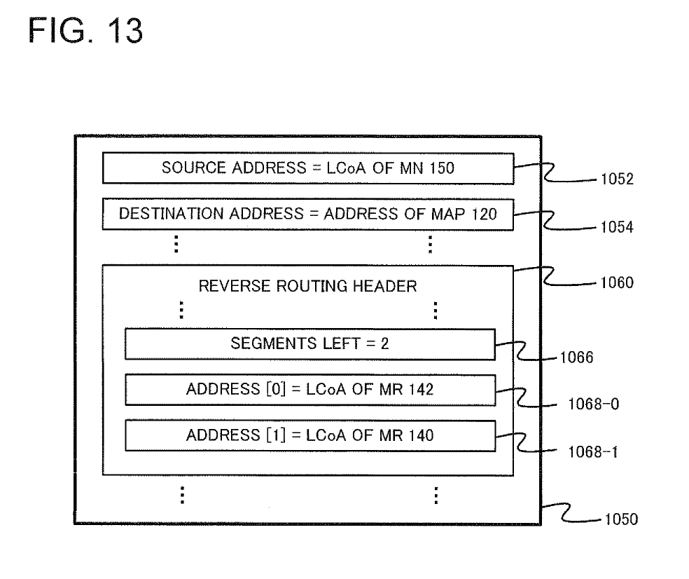

To illustrate, consider the network deployment shown in FIG. 1. Assuming that mobile routers MR 140 and MR 142 have registered with MAP 120, and that MAP 120 has prefix information of the mobile network 104 and mobile network 106 stored in its Prefix Table 340, FIG. 12 shows the contents of a tunnel packet 1000 sent from MAP 120 to MN 150, and FIG. 13 shows the contents of a tunnel packet 1050 sent from MN 150 to MAP 120.

The contents of a tunnel packet 1000 shown in FIG. 12 are the snapshot of the packet just after it is transmitted by MAP 120. That is, MR 140 and MR 142 have yet to process the routing header 1010. The source address field 1002 contains the address of MAP 120 and the destination address field 1004 contains the first Intermediate address, LCoA of the mobile router MR 140. In the routing header 1010, the segments left field 1016 contains the number 2, address [0] field 1018-0 contains the LCoA of the mobile router MR 142, and address [1] field 1080-1 contains the LCoA of the mobile node MN 150.

It should be obvious that when MN 150 receives the packet 1000, the contents of the routing header 1010 will be altered to: the segments left field 1016 contains the number 0, address [0] field 1018-0 contains the LCoA of the mobile router MR 140, and address [1] field 1018-1 contains the LCoA of the mobile router MR 142, and the destination address field 1004 contains the LCoA of the mobile node MN 150.

The contents of tunnel packet 1050 shown in FIG. 13 are the snapshot of the packet just after it is transmitted by MN 150. That is, MR 140 and MR 142 have yet to process the reverse routing header 1060. The source address field 1052 contains the LCoA of MN 150 and the destination address field 1004 contains the address of MAP 120. The reverse routing header 1060 will contain the addresses of the received routing header 1010 in reverse order, with the segments left field 1066 containing the number 2, address [0] field 1068-0 containing the LCoA of the mobile router MR 142, and address [1] field 1068-1 containing the LCoA of the mobile router MR 140.

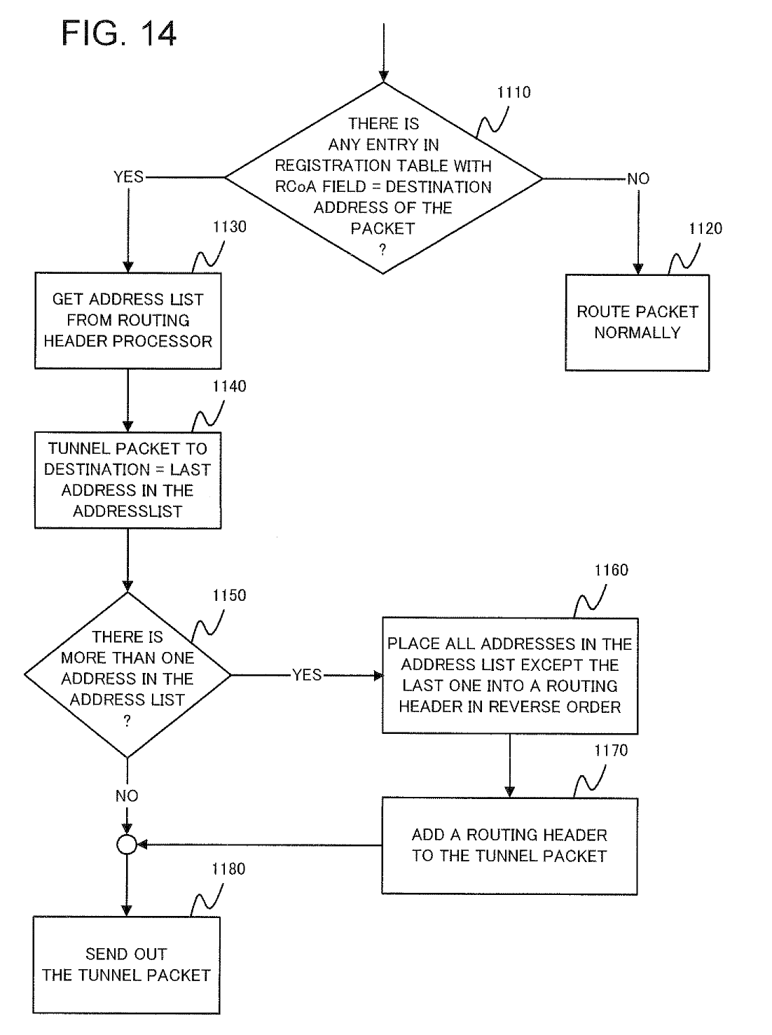

FIG. 14 shows the flowchart for the Routing Unit 620 when MAP 120 receives an incoming packet sent to an address belonging to the access network 102 that is managed by MAP 120. This shows the processing done by MAP 120 for mapping of RCoA to LCoA.

In step 1110, the destination address of the incoming packet is checked against the RCoA field 652 of the Registration Table 650 for a matching entry. If a matching entry is not found, step 1120 will be taken where the incoming packet is routed normally. On the other hand, if a matching entry is found, steps 1130, 1140, and 1150 will be taken.

In step 1130, the RCoA address (i.e. the destination address of the incoming packet) is passed to the Routing Header Processor 625 to obtain a list of intermediate addresses using the algorithm depicted in FIG. 11. Then, in step 1140, the incoming packet is encapsulated into a tunnel packet, with the destination address of the tunnel packet set to the last address in the list of intermediate addresses produced in step 1130. Although not shown, the source address of the tunnel packet is obviously set to the address of MAP 120.

In step 1150, this list of intermediate addresses is check to see if it contains more than one address. If not, there is no need for a routing header, and the tunnel packet is sent out, as shown in step 1180. If there is more than one address, step 1160 is taken where a routing header is prepared. All the addresses in the list of intermediate addresses, except for the last one (which was already used as in the destination field of the tunnel packet), are placed in the routing header in reverse order. The routing header is then added to the tunnel packet, as shown in step 1170. Finally, in step 1180, the tunnel packet is sent out.

The routing and reverse routing headers require mobile routers en route to process them correctly. We use the term mobile router here in the general sense to mean any node carrying out full or partial mobile routing functions. For the processing of the routing header, a mobile router has to check a packet for the presence of a routing header if the destination address is an address of the mobile router. If a routing header is present, the segments left field of the routing header is checked to see if it is non-zero.

If the segments left field is zero, the packet is intended for the mobile router itself. If the segments left field is non-zero, the mobile router swaps the destination address with the next unprocessed address in the routing header and decrements the segments left field. The packet is then forwarded to the new destination.

For the processing of the reverse routing header, a mobile router has to check a packet for the presence of a reverse routing header if the destination address is an address of the MAP. If a reverse routing header is present, the segments left field of the reverse routing header is checked to see if it is non-zero. If the segments left field is zero, the packet is forwarded unaltered.

If the segments left field is non-zero, the mobile router checks if the next unprocessed address in the reverse routing header is an address of the mobile router. If not, the packet is forwarded unaltered. If it is, the mobile router swaps the source address field with the next unprocessed address in the reverse routing header and decrements the segments left field. The packet is then forwarded.

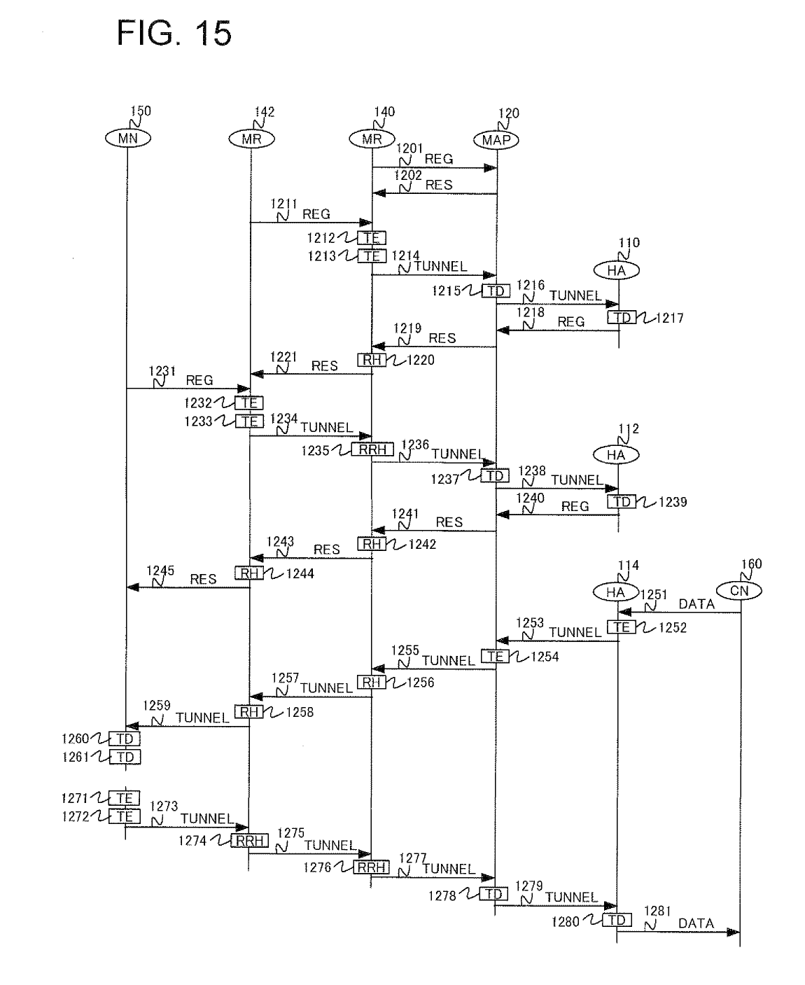

By using the routing and reverse routing headers, the object of this present invention is met. To illustrate this, consider the network deployment depicted in FIG. 1. FIG. 15 shows the message sequence of the registrations made by MR 140, MR 142 and MN 150. Note that the binding updates sent to the home agents are omitted for simplicity. In FIG. 15, a registration message, a response message, a tunnel packet, encapsulation, decapsulation, processing of a routing header and processing of a reverse routing header are referred to as REG, RES, TUNNEL, TE, TD, RH and RRH, respectively.

When the mobile router MR 140 sends a registration message 1201 to MAP 120, MAP 120 will add an entry to its Registration Table 650 containing the mapping of LCoA and RCoA of MR 140. In addition, an entry containing prefix information of the mobile network 104 is also added to the Prefix Table 640 of MAP 120. MAP 120 then replies with a successful registration response 1202.

When the mobile router MR 142 sends a registration message 1211 to MAP 120, MR 140 will intercept the message. Since there is no reverse routing header in the message 1211, MR 140 will encapsulate the packet to its home agent 110, as shown by the tunnel encapsulation (TE) process 1212. A further encapsulation 1213 to MAP 120 is necessary since encapsulation 1212 is using the RCoA of MR 140. This results in the tunnel packet 1214.

MAP 120 decapsulates the packet as shown by the tunnel decapsulation (TD) process 1215, and forwards the inner tunnel 1216 to HA 110. HA 110 decapsulates the tunnel packet 1216 (process 1217), and forwards the innermost registration request 1218 (identical to 1211) to MAP 120. MAP 120 will add an entry to its Registration Table 650 containing the mapping of LCoA and RCoA of MR 142. In addition, an entry containing prefix information or the mobile network 106 is also added to the Prefix Table 640 of MAP 120.

Furthermore, since LCoA of MR 142 is configured from the prefix associated with the mobile network 104, MAP 120 will insert a routing header in a registration response 1219 replied to MR 142. The routing header, constructed from the algorithm depicted in FIG. 11, contains only one address that is the LCoA of MR 142, with the source address of the packet equal to LCoA of MR 140. MR 140 will process the routing header by swapping the destination address with the only address in the routing header (process 1220), and forward the packet 1221 to MR 142. Thus, when MR 142 receives this response 1221, the routing header would contain the address of LCoA of MR 140, and the destination address equals to LCoA of MR 142.

When the mobile node MN 150 sends a registration message 1231 to MAP 120, MR 142 will intercept the message. Since there is no reverse routing header in the message 1231, MR 142 will encapsulate the packet to its home agent 112, as shown by the encapsulation process 1232. A further encapsulation 1233 to MAP 120 is necessary since encapsulation 1232 is using the RCoA of MR 142. This results in the tunnel packet 1234.

A reverse routing header is also inserted to the tunnel packet 1234, with only one address: LCoA of MR 140. MR 140 will intercept this packet 1234, and process the reverse routing header by swapping the source address with the address in the reverse routing header (as shown in process 1235). The packet 1235 is then routed to MAP 120, which will decapsulate the packet (process 1237), and forward the inner tunnel 1238 to HA 112. HA 112 decapsulates the tunnel packet 1238 (process 1239), and forward the innermost registration request 1240 (identical to 1231) to MAP 120.

MAP 120 will add an entry to its Registration Table 650 containing the mapping of LCoA and RCoA of MN 150. In addition, since LCoA of MN 150 is configured from the prefix associated with the mobile network 106, MAP 102 will insert a routing header in a registration response 1241 replied to MN 150. The routing header, constructed from the algorithm depicted in FIG. 11, will contain the contents as shown in FIG. 12.

MR 140 will process the routing header by swapping the destination address with the first address in the routing header (process 1242), and forward the packet 1243 to MR 142. MR 142 will process the routing header by swapping the destination address with the next address in the routing header (process 1244), and forward the packet 1245 to MN 150.

Now when CN 160 sends a packet 1251 to MN 150, the packet 1251 will first be routed to HA 114, since the packet is addressed to the home-address of MN 150. HA 114 will then tunnel the packet 1251 to the RCoA of MN 150, as shown by the process 1252. This tunnel packet 1253 will reach MAP 120. The algorithm shown in FIG. 14 will then be used by the Routing Unit 620, and the tunnel packet 1253 will again be encapsulated (process 1254) in a second tunnel, with a routing header identical to the routing header 1010 shown in FIG. 12. This second tunnel packet 1255 will be routed to the LCoA of MR 140. MR 140 will then swap the destination address with the first address in the routing header (process 1256), and forward the resulting packet 1257 to the LCoA of MR 142.

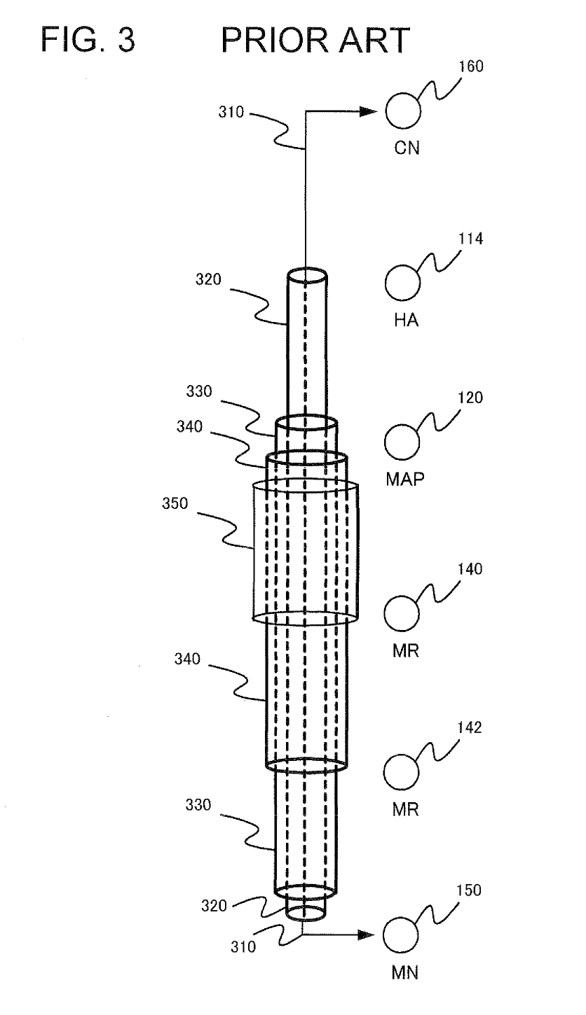

Again, MR 142 will then swap the destination address with the second address in the routing header (process 1258), and forward the resulting packet 1259 to the LCoA of MN 150. Finally, MN 150 performs two decapulations (processes 1260 and 1261) to retrieve the data packet 1251. It can be seen that from MAP 120 to MN 150, the packet only undergoes one additional encapsulation. This is a significant reduction as compared to the three additional encapsulations as shown in FIG. 3.

Conversely, when MN 150 wishes to send a packet to CN 160, it first encapsulates the packet to its home agent 114, with the source address equal to RCoA of MN 150, as indicated by process 1271. Then, the second encapsulation 1272 is necessary since packets with source address equal to RCoA of MN 150 must be encapsulated to MAP 120 for forwarding. In the second tunnel packet 1273, MN 150 inserts a reverse routing header. Contents of the reverse routing header can be derived by reversing the routing header sent to MN 150 from MAP 120 as explained earlier. Thus, the second tunnel packet 1273 will looks like the packet 1050 one shown in FIG. 13.

This second tunnel packet 1273 is first routed to MR 142. MR 142, upon inspecting the reverse routing header, swaps the source address field with the first address of the reverse routing header (process 1274). The resulting packet 1275 is then routed to MR 140. Again, MR 140, upon inspecting the reverse routing header, swaps the source address field with the second address of the reverse routing header (process 1276). The resulting packet 1277 is then routed to MAP 120 via access router AR 130.

MAP 120 then verifies the validity of the reverse routing header, decapsulates the packet (process 1278) and forwards the first tunnel packet 1279 to HA 114. HA 114 verifies the validity of the first tunnel packet, decapsulates the packet (process 1280), and forwards the innermost data packet 1281 to CN 160.

At first glance, the use of the reverse routing header and the routing header may seem to be similar to Non-Patent Document 4. However, upon closer inspection, a person skilled in the art will notice a glaring difference between the present invention and Non-Patent Document 4 which will prove to be an advantage of the present invention.

In the prior art, a sender of a reverse routing header has no way of knowing the contents of the reverse routing header beforehand. Instead, the sender relies on the intermediate routers to insert their addresses into the reverse routing header appropriately. Hence, the sender cannot protect contents of the reverse routing header with current IP security mechanisms. This poses a great risk since the receiver cannot verify the authenticity or the integrity of the received packet. With the present invention, the sender is notified of the reverse routing header beforehand. Hence, any packets sent with the reverse routing header can be protected with traditional IP security mechanisms.

In the descriptions of FIG. 15, one may wonder the purpose of a reverse routing header. Unlike the routing header which directs the packet through the intermediate routers along the path, the reverse routing header seems like extra processing without additional functionalities. In fact, the inclusion of the reverse routing header is to serve two purposes:

(1) to indicate to upstream mobile routers not to tunnel this packet to their home agents; and

(2) to overcome ingress filtering.

For the first purpose, consider the mobile router MR 142 receiving a packet from one node in its mobile network 106. The prior arts can not reveal how the mobile router MR 142 knows which packet should be tunneled to its home agent HA 112 and which packet should simply be routed upstream. The reverse routing header introduced by the present invention allows the mobile router to make such a differentiation.

The second purpose is to overcome ingress filtering. To illustrate this, consider the case when MN 150 tunnels a packet to MAP 120 without adding the reverse routing header. The packet will have a source address equal to the LCoA of MN 150, which is configured from the prefix of the mobile network 106. Suppose MR 142, after receiving the packet, somehow knows that this packet should not be forwarded from its home agent. So MR 142 will forward the packet to the mobile network 104. Now, the source address of the packet is not configured from the prefix of the mobile network 104. Mobile router MR 140 will discard this packet as bogus based on ingress filtering, unless somehow mobile router MR 140 is convinced that it should forward this packet onwards.

From the above explanation, one can see that the reverse routing header is used to inform upstream mobile routers to forward packet directly to MAP (instead of tunneling to home agent), and to overcome ingress filtering. It is possible for us to replace the reverse routing header by a special signal embedded to the outer packet. Upstream mobile routers upon seeing this special signal will not encapsulate the packet back to their home agents. Also, to overcome ingress filtering, upstream mobile routers should replace the source address of the outer packet by their respective LCoAs. In IPv6, such a special signal can be achieved by a router alert option that is inserted to the hop-by-hop header. For ease of description, this special signal is herein referred to as the Direct-Forward option, or simply DF-Option.

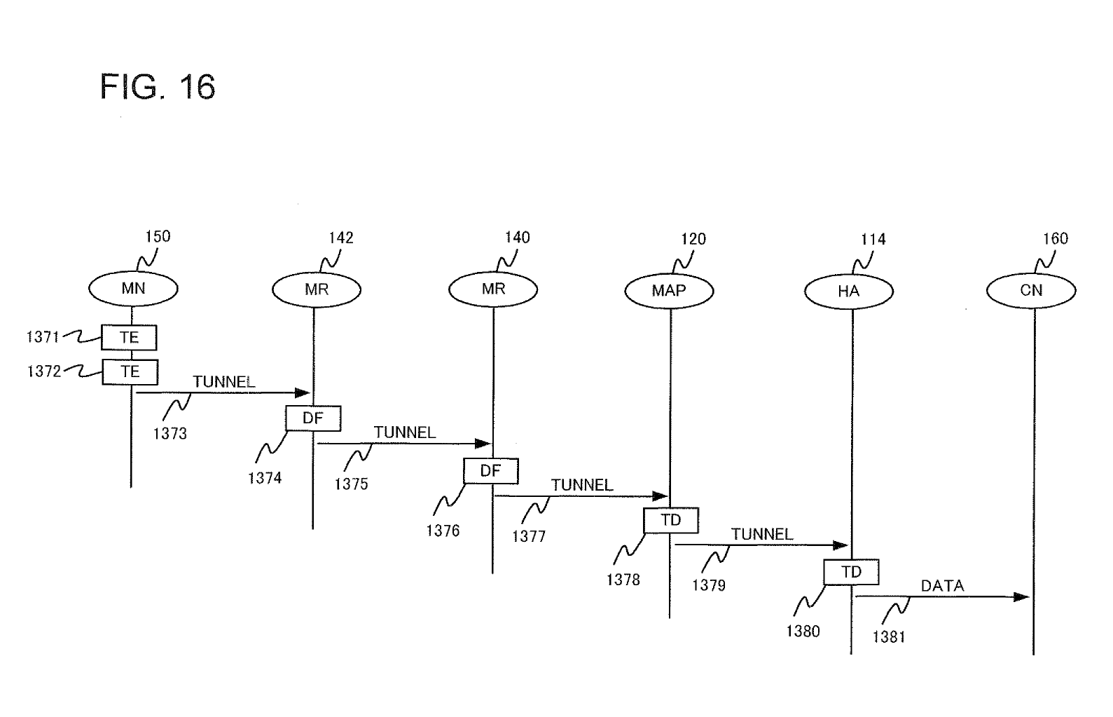

Since the outer packet serves no purpose other than to route the inner packet to the MAP, the changing of the source address by upstream mobile routers poses no significant security threats. FIG. 16 illustrates the message sequence diagram when the DF-Option is used. Here, only the portion where MN 150 has a data packet to send to CN 160 is shown.

First, MN 150 encapsulates the packet to its home agent 114, with the source address equal to RCoA of MN 150, as indicated by process 1371. Then, the second encapsulation 1372 is necessary since packets with the source address equal to RCoA of MN 150 must be encapsulated to MAP 120 for forwarding. In the second tunnel packet 1373 which has a source address equal to LCoA of MN 150, MN 150 inserts a DF-Option. This second tunnel packet 1373 is first routed to MR 142. MR 142, upon inspecting the DF-Option, changes the source address to its own LCoA, as shown in process 1374. The resulting packet 1375 is then routed to MR 140. In FIG. 16, check process of DF-Option is referred to as DF.

Again, MR 140, upon inspecting the DF-Option, changes the source address to its own LCoA, as shown in process 1376. The resulting packet 1377 is then routed to MAP 120 via access router AR 130. MAP 120 then decapsulates the packet (process 1378) and forwards the first tunnel packet 1379 to HA 114. HA 114 verifies the validity of the first tunnel packet, decapsulates the packet (process 1380) and forwards the innermost data packet 1381 to CON 160.

It is even possible to not use a reverse routing header or DE-Option and yet provide a means for upstream mobile routers to know that the packet received from downstream mobile nodes are not to be encapsulated to home agent and that the source address can be changed to the LCoA of the upstream mobile router. This is achieved by having separate prefix for downstream mobile nodes that intend to use the service of MAP. This separate prefix (henceforth referred to as S-Prefix) may be owned by the mobile router itself, or delegated by a certain node in the access network, possibly the MAP itself. When sending router advertisements, upstream mobile routers will insert this S-Prefix in a special option, so that only mobile nodes that intend to use the services of a mobility anchor point would configure their LCoA from this S-Prefix. All other nodes will simply ignore this S-Prefix.

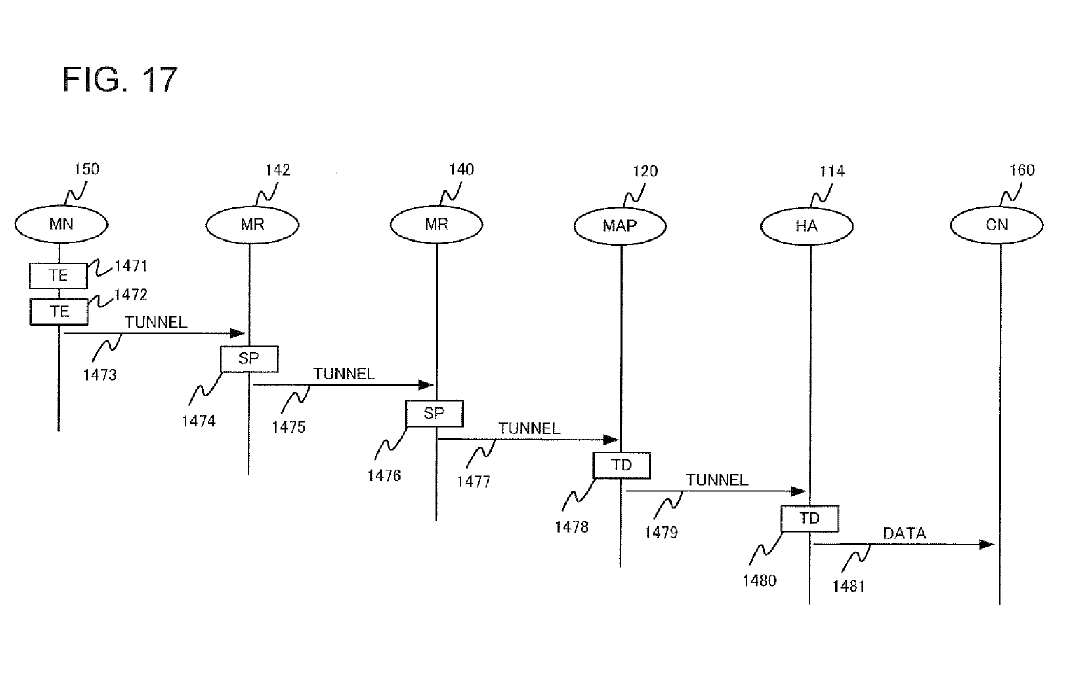

To illustrate how this works, consider again the network depicted in FIG. 1. Assuming the LCoA of the mobile node MN 150 is configured from an S-Prefix of the mobile network 106 and the LCoA of the mobile router 142 is configured from an S-Prefix of the mobile network 104. FIG. 17 illustrates the message sequence diagram when the S-Prefix is used. Here, only the portion where MN 150 has a data packet to send to CN 160 is shown.

First, MN 150 encapsulates the packet to its home agent 114, with the source address equal to RCoA of MN 150, as indicated by process 1471. Then, the second encapsulation 1472 is necessary since packets with the source address equal to RCoA of MN 150 must be encapsulated to MAP 120 for forwarding. The second tunnel packet 1473 has a source address equal to LCoA of MN 150, and is first routed to MR 142. MR 142, upon seeing that the source address of packet 1473 is configured from its S-Prefix and the destination address of packet 1473 is MAP 120, changes the source address to its own LCoA, as shown in process 1474. The resulting packet 1475 is then routed to MR 140. In FIG. 17, check process of S-Prefix is referred to as SP.

Again, MR 140, upon seeing that the source address of packet 1475 is configured from its S-Prefix and the destination address of packet 1475 is MAP 120, changes the source address to its own LCoA, as shown in process 1476. The resulting packet 1477 is then routed to MAP 120 via access router AR 130. MAP 120 then decapsulates the packet (process 1478) and forwards the first tunnel packet 1479 to HA 114. HA 114 verifies the validity of the first tunnel packet 1479, decapsulates the packet (process 1480), and forwards the innermost data packet 1481 to CN 160.

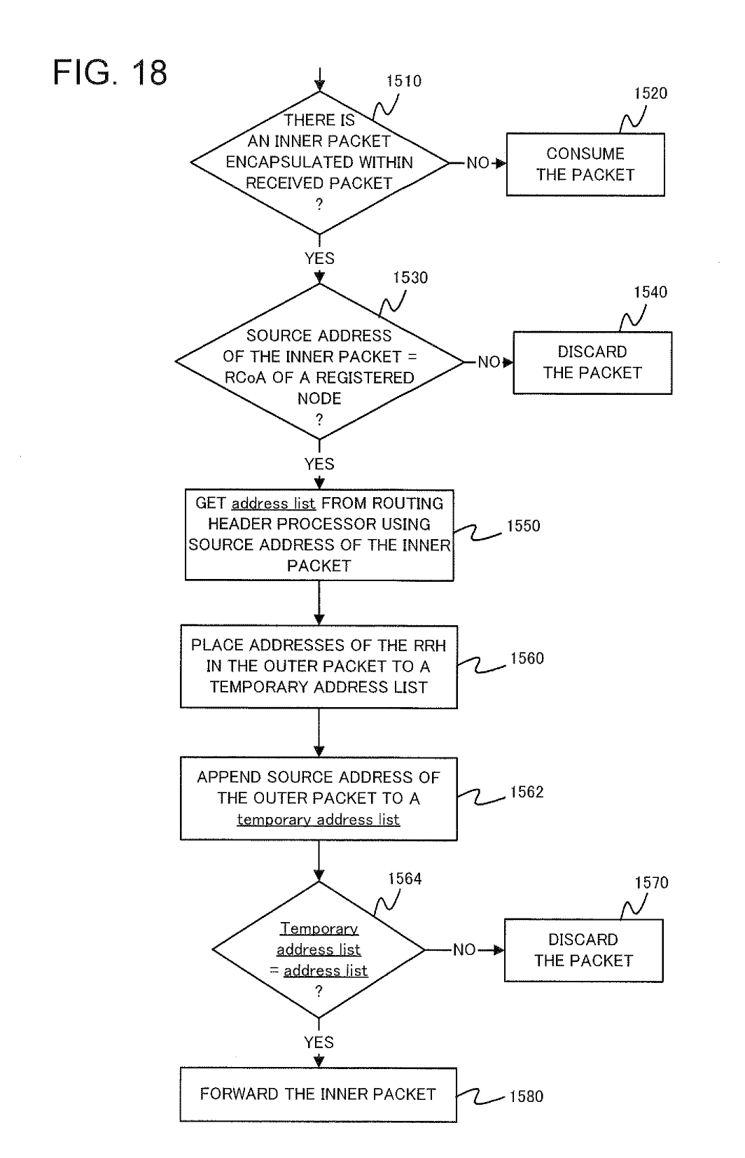

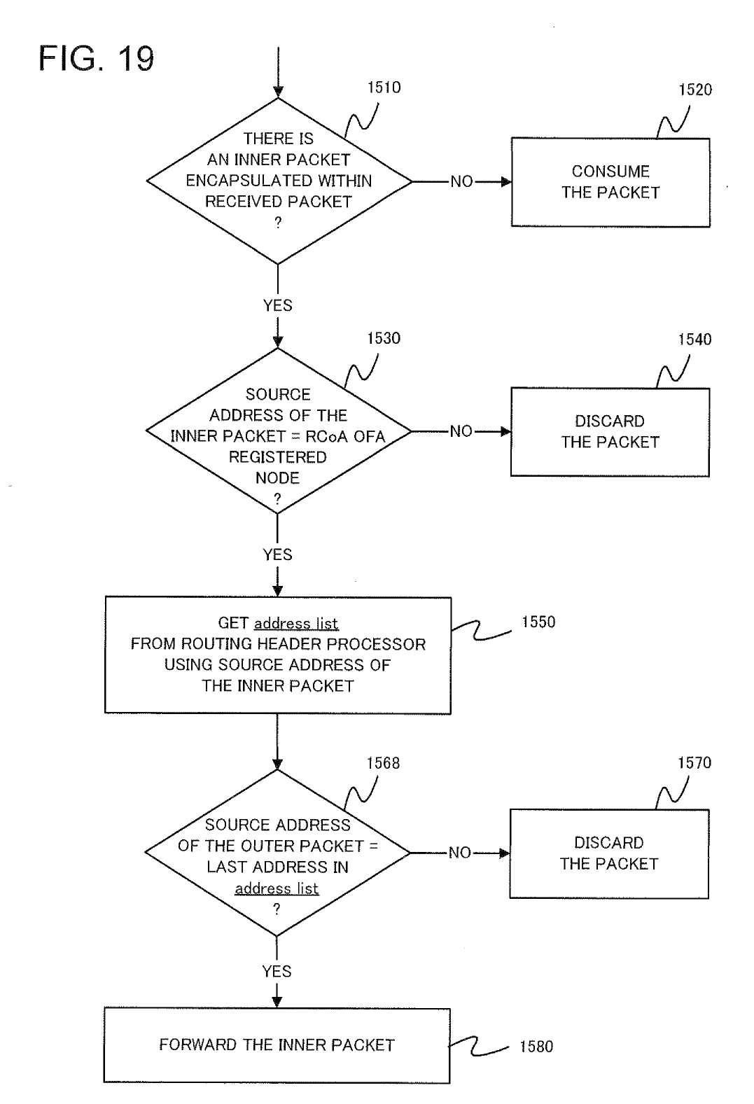

If MAP 120 is concerned with security, there are a few sanity checks MAP 120 can perform to verify the validity of a packet received from the access network segment 102 it manages before forwarding the packet to the global internet 100. FIG. 18 shows the sanity check it can perform if the reverse routing header is used. FIG. 19 shows the sanity check it can perform if DF-Option or S-Prefix is used. Notice that only a few steps are different between FIGS. 18 and 19. Those steps that are the same are hence given the same reference numerals.

When the reverse routing header is used, MAP 120 can use the algorithm depicted in FIG. 18 to process any packet addressed to MAP 120 and containing a reverse routing header. In step 1510, the received packet is first checked if it contains an encapsulated inner packet. If not, step 1520 will be taken where MAP 120 consumes a packet. This means that the packet contains data for MAP 120 itself, such as a registration message.

If there is an inner packet, then this received packet is a tunnel packet, with the intention for MAP 120 to forward the inner packet to the global internet 100. MAP 120 will proceed to perform a series of sanity checks. In step 1530, the source address of the inner packet is checked against the Registration Table 650 to see if the source address is a valid RCoA of a registered node. If not, the packet will be discarded, as shown in step 1540. On the other hand, if the source address of the inner packet is a valid RCoA of a registered node, step 1550 is taken where the Routing Header Processor 625 is then given this RCoA to generate the list of intermediate addresses using the algorithm shown in FIG. 11.

In step 1560, the addresses in the reverse routing header of the outer packet is placed in a temporary address list, and in step 1562, the source address of the outer packet is appended to the temporary address list. In step 1564, this temporary address list is then compared to the address list generated by the Routing Header Processor 625 from step 1550. If the packet is sent from a valid registered node, the two lists should be identical. Thus, if they are not the same, in step 1570, the packet is discarded. If they are the same, in step 1580, the inner packet is forwarded.

When DF-Option or S-Prefix is used, MAP 120 can use the algorithm depicted in FIG. 19 to process any packet addressed to MAP 120. The steps are largely similar to those shown in FIG. 18. The steps that are identical are given the same reference numeral and their descriptions thereof omitted. The only changes are steps 1560, 1562 and 1564 in FIG. 18 are replaced by a single step 1568.

Here, the source address of the outer packet is checked against the last address in the address list generated by the Routing Header Processor 625 from step 1550. If the packet is sent from a valid registered node, the two addresses should be identical. Thus, if they are not the same, in step 1570, the packet is discarded. If they are the same, in step 1580, the inner packet is forwarded.

Although the invention has been herein shown and described in what is conceived to be the most practical and preferred embodiment, it will be appreciated by those skilled in the art that various modifications may be made in details of design and parameters without departing from the scope and ambit of the invention. For instance, certain enhancements can be made to the Routing Header Processor 625. Since every packet addressed to the RCoA of a mobile node that is intercepted by MAP 120 must be tunneled to the mobile node with a routing header, it can be a significant burden if the algorithm in FIG. 11 is always carried out when a routing header is needed.

One way to reduce this burden is to use a routing header cache. Here the Routing Header Processor 625 will maintain a cache. Whenever there is a request to generate the list of intermediate addresses to reach a registered mobile node, instead of going straight to the algorithm shown in FIG. 11, the Routing Header Processor 625 will check if the required list of addresses is cached. If so, the list is fetched from the cache. Else, the algorithm shown in FIG. 11 is used to generate the list of addresses. This list of addresses is then cached.

When the cache is used, care has to be taken to ensure that the cache contents are not stale. One way to guarantee freshness is to invalidate all cache entries wherever there are changes made to the Prefix Table 640 or Registration Table 650. Under normal circumstances, these changes should occur less frequently compared to the number of packets sent to the RCoA of registered nodes, so it might be useful to implement a routing header cache. This, however, remains an implementation decision.

In the above description, the functionalities of the mobility anchor point and mobile routers are described. Though the MAP and the mobile router are described as separate entity, it should be appreciated by anyone skilled in the art that it is possible for a mobile router to implement functionalities of the mobility anchor point. The present invention can still be applied to such a node. In addition, it is also possible that the functionalities can be distributed. For instance, certain functionalities of the mobility anchor points can be distributed among multiple nodes, possibly in a hierarchical manner.

As yet another example, the access router AR 130 in FIG. 1 may itself implement the mobility anchor point functionality partially or fully. In fact, it is possible for AR 130 to implement the mobile router functionality partially or fully as well. One can even assume an access router implementing partially or fully both the mobility anchor point and mobile router functionalities. It should be recognized by person skilled in art that departures such as those afore-illustrated are well within the scope of the invention.

### INDUSTRIAL APPLICABILITY

The present invention has the advantage of reducing the number of encapsulations required when MAP forwards a packet to a mobile node which is layered within mobile networks, with mobile networks nested and multiple mobile routers chained behind MAP. The present invention can be applied to the communication technology of the packet-switched data communication network or the packet forwarding and processing technology.

1. A method of controlling packet forwarding in a communication system, the communication system including a mobility anchor point which manages a hierarchical network, a mobile router which comprises a mobile network and a mobile node which is attached to the mobile network, the mobility anchor point storing address binding information on a binding between a local address for identifying location of a communication node within a network of the mobility anchor point and a global address used by the correspondent node to communicate with an outside of the network, the mobile node using an address configured based on a prefix advertised within the mobile network to communicate, wherein the mobile node is attached under the mobility anchor point's control, and wherein the mobility anchor point stores the address binding information on both the mobile router and the mobile node, the method comprising:
a prefix grasping step in which the mobility anchor point grasps the prefix of the mobile network which the mobile router comprises behind; and
an immediate address list producing step in which the mobility anchor point produces an address list including a single or plurality of addresses of mobile routers which are on route from the mobility anchor point to the mobile node.

2. The method of controlling packet forwarding according to claim 1, comprising a packet forwarding step in which, when the mobility anchor point forwards a packet addressed to the global address of the mobile node, the mobility anchor point adds the address list to the packets encapsulates the packet and sets the local address of the mobile router which is located on a next hop as the destination address of the encapsulated packet.

3. The method of controlling packet forwarding according to claim 2, wherein the address list is inserted into a routing header which is appended to the encapsulated packet.

4. The method of controlling packet forwarding according to claim 2, comprising a destination address swapping step in which the mobile routers which are transfer points between the mobile node and the mobility anchor point, upon forwarding the encapsulated packet, check the address list and swap a destination address of the encapsulated packet with the local address of the mobile router described at the pre-determined point in the address list.

5. The method of controlling packet forwarding according to claim 1, comprising:
an address list acquiring step in which the mobile node acquires the address list; and
a packet sending step in which the mobile node, upon sending a packet through the mobility anchor point, adds a reverse address list in which the addresses in the address list are arranged in reverse order to the packet, encapsulates the packet and sets a destination address of the encapsulated packet to the mobility anchor point, and sends the encapsulated packet.

6. The method of controlling packet forwarding according to claim 5, wherein the reverse address list is inserted into a reverse routing header which is appended to the encapsulated packet.

7. The method of controlling packet forwarding according to claim 4, comprising a source address swapping step in which the mobile routers which are transfer points between the mobile node and the mobility anchor point, upon forwarding the encapsulated packet, check the reverse address list and swap a source address of the encapsulated packet with its own local address.

8. An apparatus for controlling packet forwarding arranged in a mobility anchor point which manages a hierarchical network, comprising;
a registration table storing means for storing address binding information on a binding between a local address for identifying location of a communication node within a network of the mobility anchor point and a global address used by the correspondent node to communicate with an outside of the network;
a prefix storing means for storing a prefix of a mobile network behind a mobile router whose address binding information is registered at the registration table storing means; and
an immediate address list producing means for producing an address list including a single or plurality of addresses of mobile routers which are on route from the mobility anchor point to the mobile node.

9. The apparatus for controlling packet forwarding according to claim 8, comprising:
an encapsulating means for, when the mobility anchor point forwards a packet addressed to the global address of the mobile node, adding the address list to the packet, and encapsulating the packet; and
an address setting means for setting the local address of the mobile router which is located on a next hop as the destination address of the encapsulated packet.

10. An apparatus for controlling packet forwarding arranged in a mobile router which comprises a mobile network, comprising;
a packet receiving means for receiving, from an upper-level mobility anchor point, an encapsulated packet which an address list including a plurality of addresses is added to;
a destination address swapping means for checking the address list and swapping a destination address of the encapsulated packet with the local address of the mobile router described at the pre-determined point in the address list; and
a packet sending means for sending the encapsulated packet that the destination address has been swapped.

11. An apparatus for controlling packet forwarding arranged in a mobile router which comprises a mobile network, comprising;
a packet receiving means for receiving, from a mobile node within the mobile network, an encapsulated packet which an address list including a plurality of addresses is added to;
a source address swapping means for checking the address list and swapping a source address of the encapsulated packet with its own local address in the address list; and
a packet sending means for sending the encapsulated packet that the source address has been swapped.

12. A communication node within a mobile network formed by a mobile router, the mobile router being under control of a mobility anchor point, comprising:
an address list acquiring step in which the mobile node acquires an address list including a single or plurality of addresses of mobile routers which are on route from the mobility anchor point to the communication node; and
a packet sending means for, upon sending a packet through the mobility anchor point, adding a reverse address list in which the addresses in the address list are arranged in reverse order to the packet, encapsulating the packet and setting a destination address of the encapsulated packet to the mobility anchor point, and sending the encapsulated packet.
